(19) United States
(12) Patent Application Publication
(10) Pub. No.: US 2005/0241458 A1
(43) Pub. Date: Nov. 3, 2005

(54) Elastomeric spring of floor tom-tom drum

(76) Inventor: Tsun-Chi Liao, Taichung City (TW)

Correspondence Address: BIRCH STEWART KOLASCH & BIRCH, PO BOX 747, FALLS CHURCH, VA, 22040-0747, US

(21) Appl. No.: 10/823,534

(22) Filed: Apr. 14, 2004

(51) Int. Cl. G10D 13/02

(52) U.S. Cl. 84/421

(57) ABSTRACT

The present invention discloses an elastomeric spring being installed at the end of a musical instrument stand such as a floor tom-tom drum or other drums. A base is substantially in an axial symmetry, wherein a protruded middle section disposed at the lower section of the base and a hollow hemispherical member inside the base define a shell wall for reducing the irregular vibrations of the musical instrument stand. The elasticity of the shell wall is used to empower the floor tom-tom drum to give a low drum base having echoes without noises.

### FIELD OF THE INVENTION

The present invention relates to an elastomeric spring, more particularly to an elastomeric spring that provides a fine low drum base and echoes without noises.

### BACKGROUND OF THE INVENTION

Different musical instruments usually adopt different musical instrument stands to set a musical instrument to an appropriate height for the performer to play the instrument. Generally, a plastic elastomeric spring is installed onto the bottom of the musical instrument stand at where the stand is in contact with the floor in order to avoid the musical instrument from damaging the floor. Please refer to FIGS. 1 and 2 for a common elastomeric spring, which is substantially a symmetrical oval cone and comprises an installation space 1 and a bottom surface 2 for supporting the musical instrument stand, and the bottom of the elastomeric spring has a plurality of protruded lines 3 to enhance the slippery-resisting effect.

Please refer to the U.S. Pat. No. 5,881,981, which disclosed an elastomeric spring, characterized in that the elastomeric spring comprises a semicircular open groove 4 penetrating through the main body of the elastomeric spring, and a plurality of transversal protruded lines 5 being in contact with the floor to enhance the slippery resisting effect, and the semicircular open groove and the main body of the elastomeric spring define a ring structure 6, and the elasticity of the ring structure 6 constitute an effect equivalent to a spring for eliminating or suppressing the irregular vibrations produced during the use of the musical instrument and thus providing better sound performance.

However, since the prior art needs to have a semicircular open groove 4 passing through the elastomeric spring, therefore the elastomeric spring cannot bear a heavy weight, or else the ring structure 6 will be deformed due to an improper excessive force. The same problem will occur after a long-time use and the elastomeric spring will be collapsed due to the deterioration of the material. Further, a transversal protruded line 5 is disposed at the bottom of the elastomeric spring to give the slippery effect when the elastomeric spring is placed on a hard smooth floor such as a marble floor or a wooden floor. Obviously, although such prior-art technology can eliminate or suppress the irregular vibrations caused by the use of the musical instrument, yet it cannot provide users the reliability for a long-time use and cannot maximize its effect for a considerably heavy musical instrument.

### SUMMARY OF THE INVENTION

The primary objective of the present invention is to provide an elastomeric spring that gives a fine low drum base and echoes without noises. The invention is capable of supporting a heavy musical instrument and providing reliability for the long-time use.

The invention discloses an elastomeric spring of a floor tom-tom drum, which comprises a base with a space mode substantially in an axial symmetry; an installation space disposed at the top of the base; a bottom surface disposed at the bottom surface of the base for inserting and securing the musical instrument stand; an protruded middle section extended outwardly from the lower section of the base; a hollow hemispherical member disposed in the protruded middle section; a shell wall being defined by the protruded middle section and the hollow hemispherical member; and a circular opening disposed at the bottom of the base and interconnected with the hollow hemispherical member.

### BRIEF DESCRIPTION OF THE DRAWINGS

FIG. 1 is a front view of a prior-art elastomeric spring.

FIG. 2 is a bottom view of a prior-art elastomeric spring.

FIG. 3 is a front view of another prior-art elastomeric spring.

FIG. 4A is a perspective view of the present invention.

FIG. 4B is a cross-section view of Section 4B-4B of FIG. 4A.

FIG. 5 is an illustrative view of the present invention when it is in use.

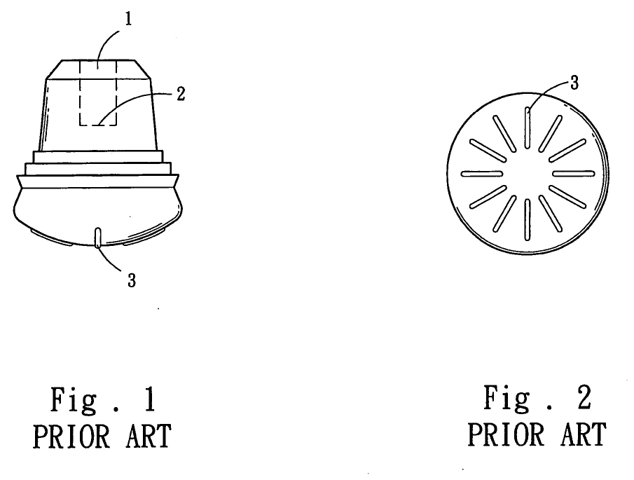

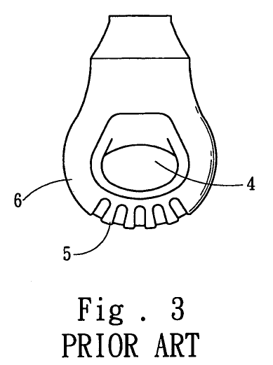

### DETAILED DESCRIPTION OF THE PREFERRED EMBODIMENTS

To make it easier for our examiner to understand the objective of the invention, its structure, innovative features, and performance, we use a preferred embodiment and the attached drawings for the detailed description of the invention.

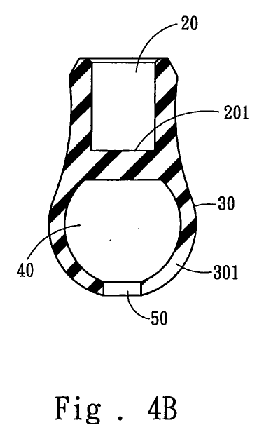

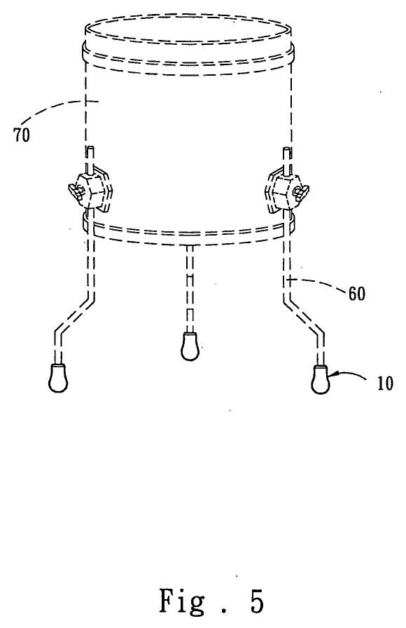

Please refer to FIGS. 4A and 4B. A base 10 made of an elastic material such as rubber has a space mode substantially in an axial symmetry, and an installation space 20 is disposed at the top of an installation space 20. The installation 20 has a bottom surface 201 for inserting and securing a musical instrument stand 60 as shown in FIG. 5. The shape of the installation space 20 is designed according to the appearance of the musical instrument stand 60. In general, the external diameter of the musical instrument stand 60 is in the shape of a cylindrical tube, and thus the installation space 20 is also in the shape of a cylindrical tube. Further, the size of the installation space 20 is slightly smaller than the musical instrument stand 60, so that the elasticity of the base 10 can press the musical instrument stand tightly into the installation space 20.

The protruded middle section 30 extended outwardly from the lower section of the base 10 comprises a hollow hemispherical member 40 therein, and a circular opening 50 disposed at the bottom of the base 10 and interconnected with the hemispherical member 40. Besides acting as a cast hole required for demolding the base 10, the circular opening 50 provides a large area of contact with the floor and gives a good slippery resisting effect. Further, the protruded middle section 30 and the hollow hemispherical member 40 define a shell wall 301.

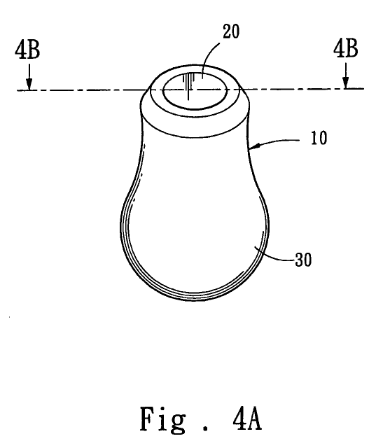

Please refer to FIG. 5 for a floor tom-tom drum 70, which comprises at least three musical instrument stands 60, each being in contact with the floor through the base 10, thereby when a user hits a floor tom-tom drum 70, the base 10 acts as a damper to reduce the irregular vibrations of the floor tom-tom drum 70 by the action of the shell wall 301 as shown-in FIG. 4B. When the user hits the floor tom-tom drum 70, the drum gives a low drum base that echoes without noises. Further, the opening 50 at the bottom of the base 10 can provide a large area of contact with the floor to achieve a good slippery-resisting effect. The shell wall 302 is a three-dimensional structure, and thus can give a better capability of bearing a heavy load than the prior-art ring structure 6 (as shown in FIG. 3), and the reliability for long-time use.

1. An elastomeric spring of floor tom-tom drum installed to an end of a musical instrument stand, comprising:
a base, being made of an elastic material and having a space mode substantially in an axial symmetry;
an installation space disposed at the top of said base;
a bottom surface, disposed in said installation space, for inserting and securing said musical instrument stand;
a protruded middle section, extended outwardly from a lower section of said base, and said protruded middle section having a hollow hemispherical member therein;
a circular opening, disposed at the bottom of said base and interconnected with said hemispherical member; and
a shell wall, defined by said protruded middle section and said hollow hemispherical member.

2. The elastomeric spring of floor tom-tom drum of claim 1, wherein said installation space has a shape designed according to the appearance of said musical instrument stand.

3. The elastomeric spring of floor tom-tom drum of claim 2, wherein said installation space has a size slightly smaller than the external diameter of said musical instrument stand, thereby said musical instrument stand is pressed tightly into said installation space by the elasticity of said base.

4. The elastomeric spring of floor tom-tom drum of claim 1, wherein said elastic material is rubber.
